(19) United States
(12) Patent Application Publication
(10) Pub. No.: US 2025/0389142 A1
(43) Pub. Date: Dec. 25, 2025

(54) AUTOMATIC DEADBOLT ASSEMBLIES AND DOOR LOCK SYSTEMS

(71) Applicant: Securitech Group, Inc., Maspeth, NY (US)

(72) Inventors: Krzysztof F. Marciniec, Glendale, NY (US); Eric Liu, Forest Hills, NY (US)

(73) Assignee: Securitech Group, Inc., Maspeth, NY (US)

(21) Appl. No.: 19/243,842

(22) Filed: Jun. 20, 2025

Related U.S. Application Data
(60) Provisional application No. 63/662,837, filed on Jun. 21, 2024.

(51) Int. Cl. E05C 9/06; E05C 9/12; E05C 9/20

(52) U.S. Cl. CPC E05C 9/06; E05C 9/12; E05C 9/20

(57) ABSTRACT

A deadbolt assembly is disclosed. The deadbolt assembly includes a deadbolt configured to be automatically deployed upon actuation of a trigger. A door lock system with at least two deadbolt assemblies is also disclosed. The deadbolt assemblies may be operatively connected, such that actuation of the trigger of each deadbolt assembly allows all deadbolts to be deployed in unison.

### CROSS REFERENCE TO RELATED APPLICATIONS

This Application claims the benefit of priority under 35 U.S.C. § 119(e) of U.S. Provisional Application Ser. No. 63/662,837, filed Jun. 21, 2024, the disclosure of which is incorporated herein by reference in its entirety.

### FIELD

The field is related to automatic deadbolts and door lock systems incorporating automatic deadbolts.

### BACKGROUND

Door lock systems often include deadbolts which are configured to extend from a door and into corresponding pockets in a door jamb in order to prevent opening of the door. Some door lock systems include multiple deadbolts for increased security. While many door lock systems require manual actuation of the deadbolt(s) (e.g. by physically turning a key or a thumb turn) in order to extend the deadbolts, some door lock systems are configured to automatically extend the deadbolt(s) when the door is closed to obviate the need for manual actuation of the deadbolt(s).

### SUMMARY

According to some aspects, an automatic deadbolt assembly is provided. The automatic deadbolts assembly comprises a deadbolt configured to move between a deadbolt retracted position and a deadbolt extended position. At least a portion of the deadbolt is configured to be received into a pocket of a door jamb in the deadbolt extended position. The deadbolt is configured to be biased towards the deadbolt extended position by a deadbolt biasing mechanism. The automatic deadbolt assembly also comprises a clamp configured to move between a grasped position, where the clamp grasps the deadbolt to prevent movement of the deadbolt to the extended position, and a released position, where the clamp releases the deadbolt, and a trigger operatively connected to the clamp and configured to move approximately parallel to the deadbolt between a trigger extended position and a trigger retracted position. The trigger is configured to move the clamp to the released position when the trigger is moved to the trigger retracted position, allowing the deadbolt to move to the deadbolt extended position via force from the deadbolt biasing mechanism.

According to some aspects, a lock system is provided, the door lock system comprising a first deadbolt and a second deadbolt, each deadbolt configured to move between respective deadbolt retracted positions and deadbolt extended positions, a transmission unit assembly extending between and operatively connecting the first deadbolt to the second deadbolt, such that the deadbolts move together between respective deadbolt extended and deadbolt retracted positions, a deadbolt biasing mechanism configured to bias the deadbolts to respective deadbolt extended positions, a first clamp configured to move between a grasped position, where the first clamp grasps the first deadbolt to prevent movement of the deadbolts to the respective extended positions, and a released position, where the first clamp releases the first deadbolt, a first trigger operatively connected to the first clamp and configured to move the first clamp to the released position when the first trigger is actuated, a second clamp configured to move between a grasped position, where the clamp grasps the second deadbolt to prevent movement of the deadbolts to the respective extended positions, and a released position, where the second clamp releases the second deadbolt, and a second trigger operatively connected to the second clamp and configured to move the second clamp to the released position when the second trigger is actuated. Simultaneous actuation of the first trigger and second trigger simultaneously moves the first and second clamps to respective released positions, allowing the deadbolt biasing mechanism to move the deadbolts to respective deadbolt extended positions.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a right-side view if a door lock system according to an embodiment;

FIG. 2 shows a left-side view of a lock body of the door lock system of FIG. 1 in a deadbolt extended position;

FIG. 3 shows a left-side view of a lock body of the door lock system of FIG. 1 in a deadbolt retracted position;

FIG. 4 shows a left-side view of a lock body according to another embodiment;

FIG. 5 shows a perspective view of a peripheral deadbolt assembly of the door lock system of FIG. 1;

FIG. 6 shows a right-side view of the peripheral deadbolt assembly of FIG. 5 in a deadbolt retracted position;

FIG. 7 shows a right-side view of the peripheral deadbolt assembly of FIG. 5 in a deadbolt extended position;

FIG. 8 shows a bottom view of the peripheral deadbolt assembly of FIG. 5;

FIG. 9 shows a perspective view of a peripheral deadbolt assembly according to another embodiment;

FIG. 10 shows a right-side cross-sectional view of the peripheral deadbolt assembly of FIG. 9 in a deadbolt retracted position; and

FIG. 11 shows a right-side cross-sectional view of the peripheral deadbolt assembly of FIG. 9 in a deadbolt extended position.

### DETAILED DESCRIPTION

As discussed above, some door lock systems include multiple automatic deadbolts configured to automatically extend into corresponding receiver pockets in a door jamb when the door is closed. Such deadbolts may be operatively connected, such that all deadbolts move in unison between extended and retracted positions. Such deadbolts may be biased towards the extended position via a biasing mechanism. A clamp may grasp one of the deadbolts, holding that deadbolt in the retracted position. Because the deadbolts are operatively connected, holding one deadbolt in the retracted position therefore holds all the deadbolts in the retracted positions. The clamp may be released by a trigger configured to be actuated when the door is closed, allowing all the deadbolts to be moved to the extended position via the biasing mechanism.

However, the inventors have recognized that it may be undesirable to have all deadbolts in a door lock system dependent on a single trigger mechanism. If the trigger is faulty or misaligned, the deadbolts may not be held in the retracted position, or may be extended prematurely, such that they contact a portion of the door jamb rather than be received into the receiver pockets. Additionally, accidental actuation of the trigger may cause the deadbolts to extend when the door is open.

The inventors have therefore recognized an advantage to a door lock system with multiple triggers. Each trigger may be operatively connected to a clamp, each clamp configured to grasp a separate deadbolt. If all the triggers are actuated, all the clamps are released, and the deadbolts are permitted to extend. However, if all the triggers are not actuated (e.g. if a person accidentally actuates one of the triggers), at least one of the clamps will still hold one of the deadbolts in the retracted position, which in turn prevents all the deadbolts from moving to the extended positions.

Additionally, current trigger mechanisms include a flap portion which rotates upon contact with the door jamb. The flap portion may be operatively connected to the clamp, such that when the flap portion is fully rotated, the clamp releases the deadbolt.

The inventors have recognized that such current trigger mechanisms may be unsightly, and thus less suitable for use when the triggers will be visible (e.g. when the deadbolt extends horizontally into a side of the door jamb). Additionally, the inventors have recognized that such trigger mechanisms may require the clamp to be positioned closely to the flap portion and thus require the clamp to grasp a head portion of the deadbolt. This may significantly limit the size and shape of the deadbolt, as well as limit flexibility in positioning various components of the deadbolt assembly relative to each other.

The inventors have therefore recognized an advantage to a trigger configured to move in a direction approximately parallel to the direction which the deadbolt travels between the extended and retracted positions. Such a configuration may allow for the trigger to more closely resemble conventional door latches, leading to a more visually pleasing door lock system overall. Additionally, such a configuration may allow for more flexibility in positioning the clamp relative to the trigger. Because the trigger slides approximately parallel to the deadbolt, the clamp may be positioned at any point along the length of the deadbolt simply by positioning the clamp at a corresponding point along the length of the trigger. For instance, the clamp may be configured to grasp a rear portion of the deadbolt. This may allow the head portion of the deadbolt to be larger and/or a different shape than would be feasible if the clamp needed to grasp the head portion. In some embodiments the deadbolt head may be removable from the rear portion of the deadbolt, allowing a different deadbolt head to be attached which corresponds to a different receiver pocket.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

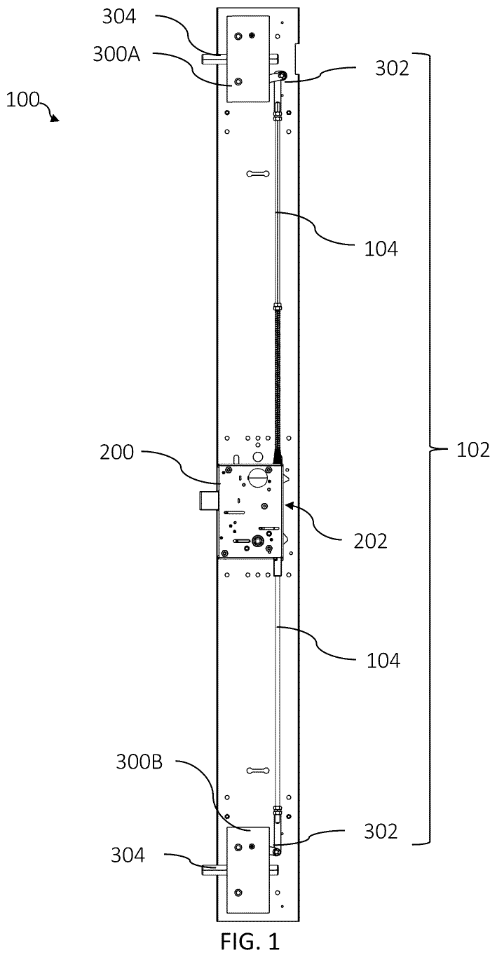

FIG. 1 shows a right-side view of a door lock system 100 according to an embodiment. The door lock system 100 includes a lock body 200. Lock body 200 may be configured to engage with lock trim assemblies, such that the door lock system may be actuated by a user interacting with the lock trim assembly. For instance, the lock trim assembly may include a lock trim actuator (e.g. a handle, a knob, a motor, etc.) which may be used to actuate the door lock system, as discussed further below. The lock trim assembly may also include any suitable locking mechanism (e.g. a key cylinder, an electromechanical lock, etc.), to selectively prevent actuation of the door lock system.

The door lock system 100 may also include at least one peripheral deadbolt assembly 300 external to the lock body 200. For instance, as seen in FIG. 1, the door lock system includes first peripheral deadbolt assembly 300A and second peripheral deadbolt assembly 300B. However, it is contemplated that the door lock system may include any number of peripheral deadbolt assemblies, as the disclosure is not so limited. Each peripheral deadbolt assembly 300 may include at least one deadbolt 304 configured to be received into a corresponding pocket in a door jamb or support surface (e.g. a floor). In some embodiments, the lock body 200 may also include a deadbolt 204. While FIG. 1 shows each deadbolt 204/304 extending approximately parallel to each other, such that each deadbolt is configured to be received into a side of the door jamb, it is contemplated that different deadbolts may extend in different directions and be configured to be received into different portions of the door jamb and/or support surface.

Each deadbolt 304 and/or 204 may be operatively connected to each other via transmission unit assembly 102. The transmission unit assembly 102 may include a lock body transmission unit 202 disposed at least partially in or adjacent to the lock body 200. If the door lock system 100 includes a lock body deadbolt 204, the lock body deadbolt 204 may be operatively connected to the lock body transmission unit 202. The transmission unit assembly 102 also includes at least one peripheral transmission unit 302 operatively connected to a respective peripheral deadbolt 304, each peripheral transmission unit 302 being disposed at least partially in or adjacent to a respective peripheral deadbolt assembly 300. The transmission unit assembly 102 may also include at least one connector rod 104 configured to operatively connect each peripheral transmission unit 302 to the lock body transmission unit 202. When operatively connected by the transmission unit assembly 102, each deadbolt 204/304 may be configured to move in unison, such that extending one deadbolt extends all the deadbolts, and preventing one deadbolt from extending prevents all deadbolts from extending. More details on each transmission unit will be discussed further below.

As discussed above, it may be desirable for all the deadbolts 204/304 in the door lock system 100 to automatically move to the deadbolt extended positions when the door is closed. Therefore, the deadbolts may be biased towards the deadbolt extended positions by at least one biasing mechanism, but held in the deadbolt retracted position by at least one clamp grasping a deadbolt. A trigger may be configured to contact the door jamb. This contact may cause the trigger to actuate the clamp to release the deadbolt, allowing the biasing mechanism(s) to automatically move all the deadbolts to the extended positions.

However, the inventors have recognized that it may be desirable to require actuation of multiple clamps by multiple triggers to limit the likelihood of accidental/premature deadbolt extension. In some embodiments, two or more peripheral deadbolt assemblies 300 each include a clamp configured to grasp the peripheral deadbolt 304 and a trigger configured to actuate the clamp to release the peripheral deadbolt 304. Because all the deadbolts in the door lock system are operatively connected by the transmission unit assembly 102, all the clamps must be released for the deadbolts to move to the deadbolt extended positions. This requires all the triggers to be actuated at the same time, which is likely to only occur when the door is closed, and the triggers contact the door jamb. More details about the specifics of the lock body and the peripheral deadbolt assemblies will be discussed further below.

Additionally, while the following describes the peripheral deadbolt assemblies 300 including clamps and triggers, it is also contemplated that the lock body 200 may be modified to include a clamp configured to grasp the lock body deadbolt 204, and a trigger configured to move this clamp to release the lock body deadbolt 204 when the trigger is moved to the actuated position, as the disclosure is not so limited. Therefore, in some embodiments, the door lock system 100 includes a lock body 200 with a lock body deadbolt 204 and a single peripheral deadbolt 304, with each of the deadbolts 204 and 304 configured to engage with respective clamps and triggers.

In some embodiments, such as embodiments where multiple peripheral deadbolt assemblies are disposed above and/or below the lock body 200, the peripheral transmission units 302 may be serially connected to the lock body transmission unit 202. For instance, if a third peripheral deadbolt assembly 300 were disposed between lock body 200 and first peripheral deadbolt assembly 300A, a first connector rod 104 may connect the peripheral transmission units of first and third peripheral deadbolt assemblies together, and a second connector rod may connect the peripheral transmission unit of the third deadbolt assembly to the lock body transmission unit. Alternatively, a single connector rod may operatively connect the transmission units 302 of the first and third deadbolt assemblies to the lock body transmission unit 202. While FIG. 1 shows lock body 200 disposed between the peripheral deadbolt assemblies 300, it is contemplated that all peripheral deadbolt assemblies may be disposed above or below the lock body 200, or the door lock system 100 may include an uneven number of peripheral deadbolt assemblies disposed above the lock body 200 compared to below the lock body 200.

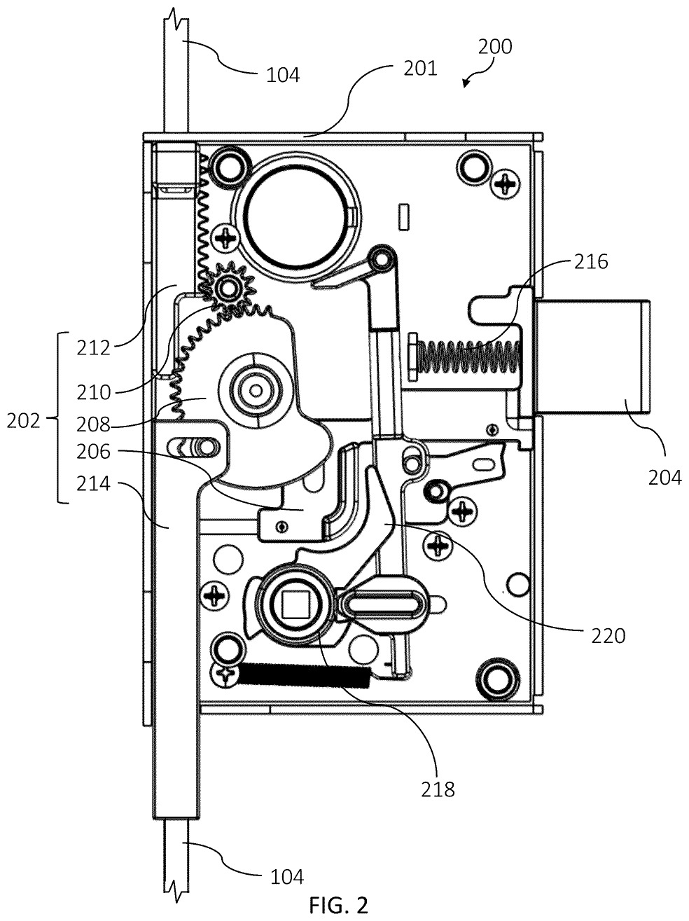

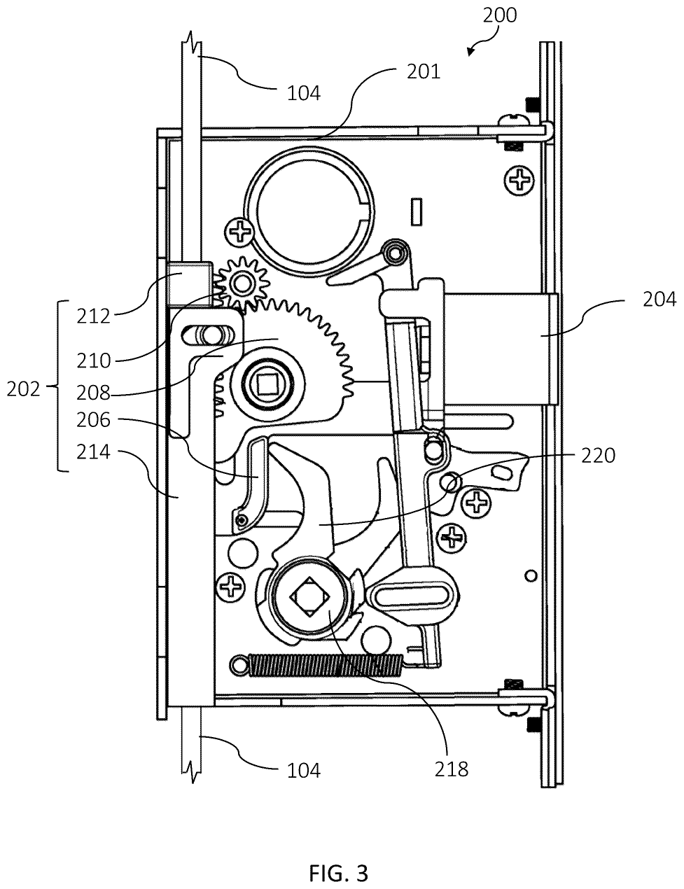

FIGS. 2 and 3 show left side views of a lock body 200 in a deadbolt extended position and a deadbolt retracted position respectively, according to an embodiment with a portion of the housing 201 removed. In some embodiments, lock body 200 is substantially similar to the lock body disclosed in U.S. Pat. No. 11,702,864, which is incorporated by reference herein.

As discussed above, lock body 200 may include a lock body transmission unit 202 configured to operatively connect each deadbolt in the lock system 100. The lock body transmission unit 202 includes a connector linkage 206, a large gear 208, a small gear 210, an upper deadbolt connector 212, and a lower deadbolt connector 214, with each component configured to move between the deadbolt extended position shown in FIG. 2 and the deadbolt retracted position shown in FIG. 3.

The lock body transmission unit 202 may be moved from the deadbolt extended position to the deadbolt retracted position via the lock trim actuator. The lock trim actuator may include a lock spindle configured to engage with spindle cam 218, such that as the lock trim actuator is rotated about a lock axis, the spindle cam is also rotated about the lock axis. The spindle cam 218 may include a cam arm 220 configured to contact the connector linkage 206 and move the connector linkage 206 to the deadbolt retracted position shown in FIG. 3. Connector linkage 206 may be operatively connected to lock body deadbolt 204, such that moving the connector linkage 206 to the deadbolt retracted position moves the lock body deadbolt 204 to the retracted position. Connector linkage 206 may also be operatively connected to large gear 208, such that as connector linkage 206 slides to the deadbolt retracted position, the large gear 208 rotates to the deadbolt retracted position shown in FIG. 3. The large gear 208 may be operatively connected to the upper deadbolt connector 212 via small gear 210, and to the lower deadbolt connector 214, such that as the large gear 208 rotates to the deadbolt retracted position, the upper and lower deadbolt connectors 212 and 214 slide to the deadbolt retracted position. The upper and lower deadbolt connects 104 may be connected to the connector rods 104, each of which connect to at least one peripheral deadbolt 304 via peripheral transmission units 302, as discussed above. As a result, moving the connector linkage 206 to the deadbolt retracted position may move all deadbolts in the door lock system to the retracted position.

The door lock system 100 may also include a deadbolt biasing mechanism 216 (e.g. a spring) configured to bias all the deadbolts to the deadbolt extended positions. As seen in FIG. 2, the biasing mechanism 216 may be disposed in lock body 200 and configured to contact the lock body deadbolt 204 and bias the lock body deadbolt 204 towards the extended position. Because the lock body deadbolt 204 is operatively connected to transmission unit assembly 102 via connector linkage 206, biasing the lock body deadbolt 204 towards the lock body extended position also biases all peripheral deadbolts to the deadbolt extended positions via the transmission unit assembly 102. While biasing mechanism 216 is shown as a spring contacting lock body deadbolt 204, it is contemplated that any suitable biasing mechanism may be configured to bias any deadbolt or any component in the transmission unit assembly 102 to the deadbolt extended position in order to bias all deadbolts towards the deadbolt extended positions, as the disclosure is not so limited. For instance, the biasing mechanism 216 may be a torsion spring configured to bias large gear 208 towards the deadbolt extended position.

Additionally, while lock body 200 is shown with a lock body deadbolt 204, the door lock system 100 could be configured to only include peripheral deadbolts 304. As discussed above, the biasing mechanism 216 could be configured to bias one of the peripheral deadbolts, or one of the components in the transmission unit assembly 102, towards the deadbolt extended position. Also, if the door lock system only includes peripheral deadbolt assemblies either above or below the lock body, the lock body may only include either upper or lower deadbolt connector, rather than both.

While the above embodiments disclose a lock body 200 with a deadbolt 204 configured to move in unison with peripheral deadbolt(s) 304. It is also contemplated that the lock body of door lock system 100 may include a door latch in addition to, or as an alternative to, deadbolt 204.

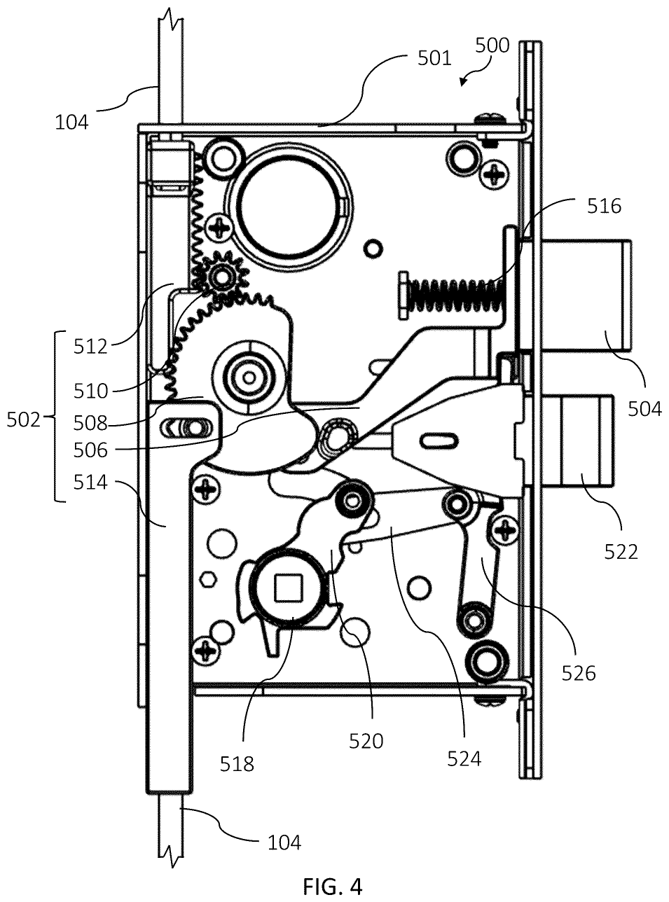

For instance, FIG. 4 shows a left-side view of an alternative lock body 500 with a portion of the lock body housing 501 removed. Much of lock body 500 operates substantially similarly to lock body 200, with lock body transmission unit 502 corresponding to lock body transmission unit 202. However, In lock body 500, the cam arm 520 of spindle cam 518 is operatively connected to cam linkages 524 and 526. The cam linkages 524 and 526 are configured to move the connecting linkage 506 to the deadbolt retracted position, which itself in turn moves deadbolt 504, large gear 508, small gear 510, upper deadbolt connector 512, and lower deadbolt connector 514 to the deadbolt retracted positions, similar to connector linkage 206 above. Additionally, biasing mechanism 516 biases the deadbolts to the extended positions, similar to biasing mechanism 216 above. However, lock body 500 also includes door latch 522. Door latch 522 is configured to be moved to the retracted position with lock body deadbolt 504. However, because door latch 522 is not operatively connected to the peripheral deadbolt(s) 304 via transmission unit 502, door latch 522 is not held in the retracted position by the clamp(s) of the peripheral deadbolt assemblies (as discussed further below). As a result, when the lock trim actuator is returned to its original position, the door latch 522 also moves to the door latch extended position via force from the spindle cam 518, and spindle cam linkages 524 and 526 as these components return to their original positions with the lock trim actuator.

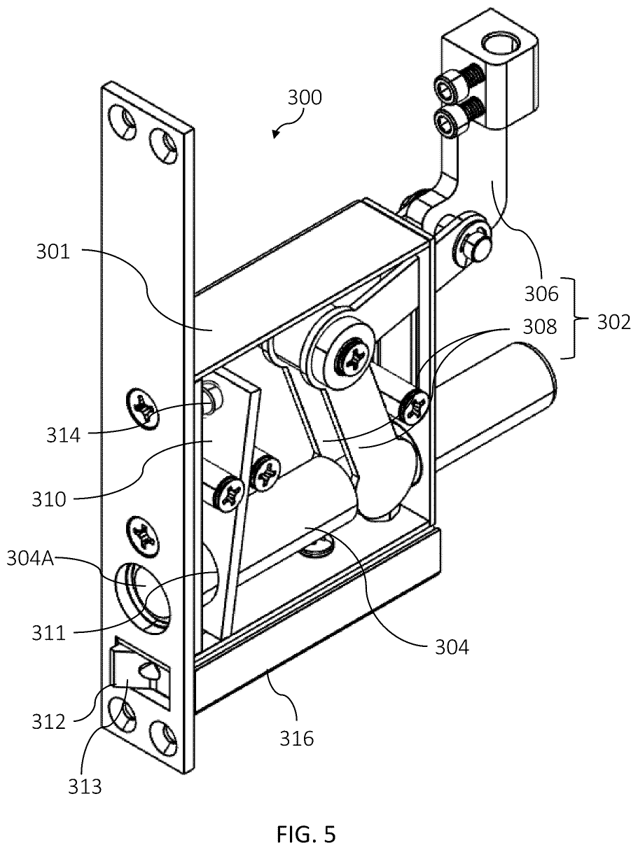

FIG. 5 shows a perspective view of a peripheral deadbolt assembly 300 according to an embodiment, with a portion of the housing 301 removed. The peripheral deadbolt assembly 300 may include a peripheral transmission unit 302 configured to operatively connect the peripheral deadbolt 304 with the other deadbolt(s), the biasing mechanism(s), and the lock trim actuator via the transmission unit assembly 102. As discussed above, the peripheral deadbolt 304 may be moved to the retracted position shown in FIG. 5 via actuation of the lock trim actuator.

The peripheral deadbolt assembly 300 may include a clamp 310 configured to grasp a portion of the peripheral deadbolt and prevent the peripheral deadbolt from moving to the deadbolt extended position. Because all deadbolts are operatively connected, clamp 310 therefore prevents all deadbolts from moving to the deadbolt extended position when grasping a peripheral deadbolt 304. As a result, all deadbolts are held in the deadbolt retracted position even after spindle cam 218 returns to its original position (e.g. after a user releases the lock trim actuator).

As discussed above, it may be desirable for the deadbolts in the door lock system 100 to be configured to move to the extended position automatically when the door is closed. Therefore, as discussed above, the deadbolts in the door lock system may be biased towards the extended position via biasing mechanism 216, but held back in the deadbolt retracted position by the clamp 310. As a result, once all clamps 310 are released, the biasing mechanism 216 will move all the deadbolts to the deadbolt extended positions.

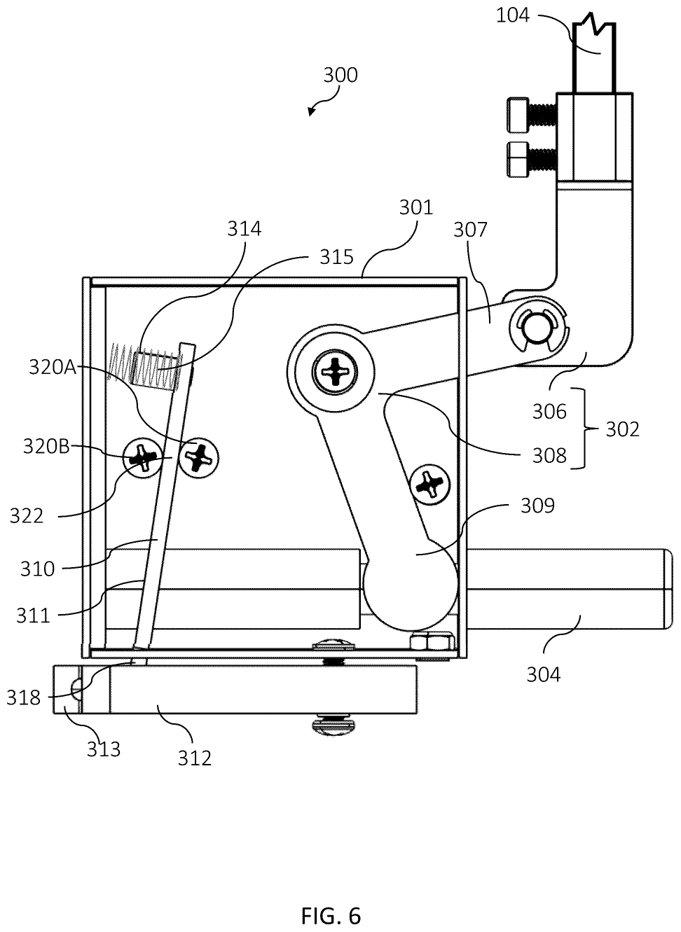

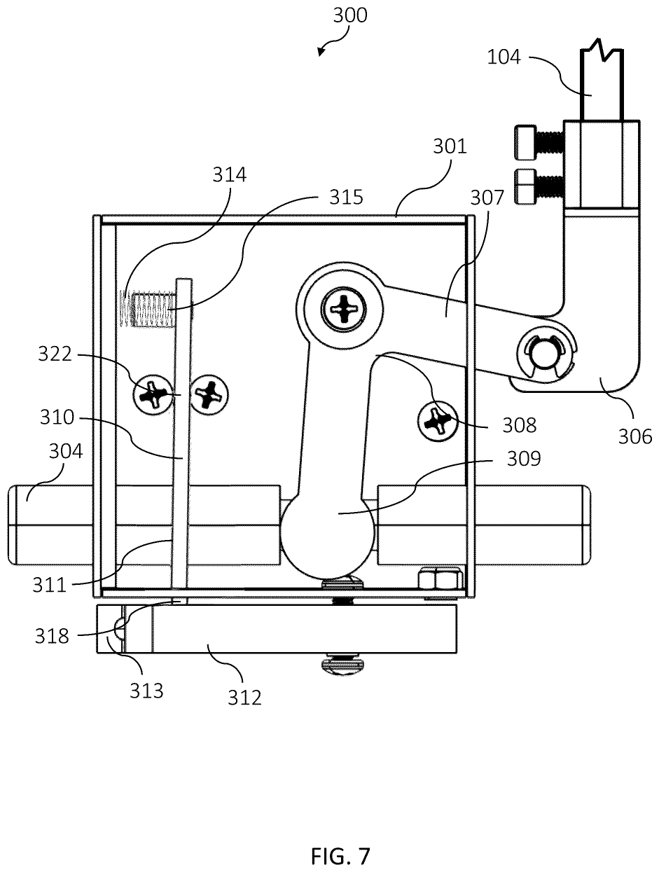

FIGS. 6 and 7 shows right side views of peripheral deadbolt assembly 300 in deadbolt retracted and extended positions, respectively, with a portion of the housing 301 removed. As discussed above, each peripheral deadbolt 304 may be moved to the deadbolt retracted position via actuation of the lock trim actuator. When the lock trim actuator is actuated, the upper and/or lower deadbolt connectors 212 and 214 are configured to retract into the lock body 200, pulling the connector rods 104 towards the lock body 200. As seen in FIG. 6, each connector rod may be attached to sliding linkage 306, such that sliding linkage 306 moves towards the lock body 200 with the connector rod 104. Sliding linkage 306 is attached to a first arm 307 of rotating linkage 308, such that sliding linkage exerts a torque to rotate the rotating linkage 308 in a first direction (e.g. counter-clockwise in FIG. 6). Rotating linkage 308 may include a second arm 309 configured to interlock with the peripheral deadbolt 304. As the rotating linkage 308 rotates in the first direction, second arm 309 exerts a force on the peripheral deadbolt 304 to move the peripheral deadbolt to the deadbolt retracted position. As the peripheral deadbolt 304 is moved to the retracted position, the biasing mechanism 216 is deformed, storing potential energy, and biasing the peripheral deadbolt 304 towards the extended position.

In some embodiments, the rotating linkage 308 rotates about an axis of rotation which is approximately perpendicular to the direction of travel of the peripheral deadbolt. In some embodiments, the sliding linkage 306 connects to the rotating linkage 308 with a pin which slots through corresponding holes in the linkages 306 and 308, such that a path of travel of the sliding linkage 306 between positions shown in FIGS. 6 and 7 is an arc with a center at the axis of rotation of the rotating linkage 308. In some embodiments, sliding linkage 306 includes a horizontal (e.g. the direction of travel of the peripheral deadbolt 304) slot where the sliding linkage connects to rotating linkage 308, allowing for horizontal movement of the sliding linkage as it travels between positions. As a result, sliding linkage 306 slides approximately perpendicular to the direction of travel of the peripheral deadbolt 304, and approximately perpendicular to the axis of rotation of the rotating linkage 308.

As discussed above, the peripheral deadbolt 304 may be held in the deadbolt retracted position against the force exerted by biasing mechanism 216 by clamp 310. Clamp 310 may function substantially similar to a Jorgenson clamp. For instance, clamp 310 may include a hole 311 configured to correspond to a profile of the peripheral deadbolt 304. When the clamp is in the grasped position shown in FIG. 6, the clamp 310 may be tilted at an angle relative to the direction of travel of the peripheral deadbolt 304, such that an edge of hole 311 binds against an outer surface of the peripheral deadbolt.

Clamp 310 may be moved from the grasped position of FIG. 6 to the released position of FIG. 7 via actuation of trigger 312. Trigger 312 may be configured to slide from a trigger extended position shown in FIG. 6 to a trigger retracted position shown in FIG. 7, in a direction of travel approximately parallel to the direction of travel of the peripheral deadbolt 304. As discussed above, such a configuration may allow the trigger 312 to more closely resemble a conventional door latch, leading to a more visually pleasing appearance overall. Such a configuration also allows the clamp 310 to be partially or fully disposed within the peripheral deadbolt assembly housing 301. Because the clamp 310 may be fully or partially disposed in the housing, a head portion 304A of the peripheral deadbolt may be fully disposed in the housing 301, such that the deadbolt 304 does not protrude from a front of the housing 301, as best seen in FIG. 5. The trigger 312 may be operatively connected to the clamp 310, such that a lower portion 318 of the clamp moves with the trigger 312. However, the clamp 310 may be prevented from sliding with the trigger by projections 320A and 320B, such that the clamp 310 must rotate to a released position about pivot point 322 as the lower portion 318 is moved by the trigger 312. As the clamp 310 rotates to be closer to perpendicular with the direction of travel of the peripheral deadbolt, hole 311 becomes more aligned with the cross-sectional profile of the peripheral deadbolt 304, reducing or removing the binding force between the hole 311 and the peripheral deadbolt 304. This allows the biasing mechanism 216 to move the peripheral deadbolt 304 to the deadbolt extended position.

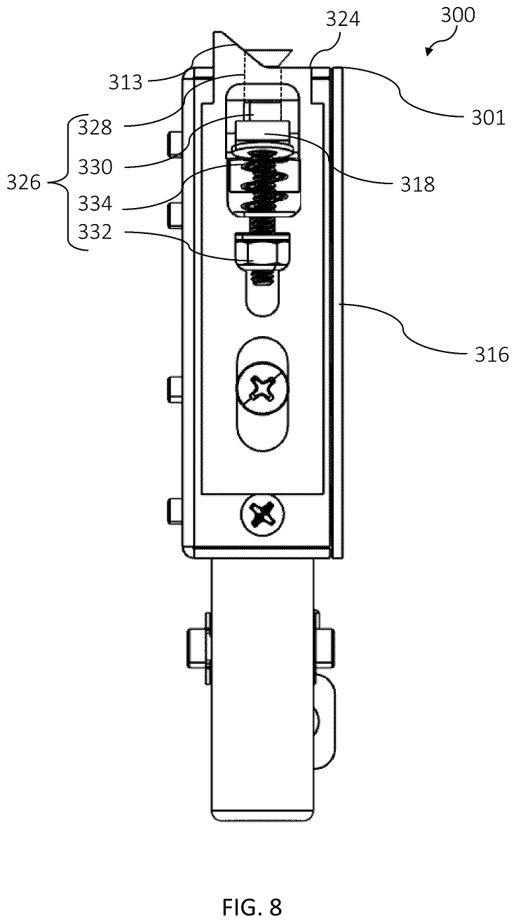

In order to actuate the trigger, the trigger 312 may include a camming surface 313 configured to contact a portion of the door jamb. As the door is being closed, the camming surface 313 contacts a side of the door jam, pushing the trigger to the trigger retracted position. In some embodiments, as best seen in FIG. 8, the camming surface 313 may be offset from a leading edge 324 of the trigger. Such a configuration may ensure that the trigger is not pushed to the retracted position until the peripheral deadbolt 304 is aligned with the corresponding receiver pocket in the door jamb.

When the door is closed, the trigger 312 may remain in the trigger retracted position shown in FIG. 7 due to contact with the door jamb, holding the clamp 310 in the released position. Such a configuration may allow for the peripheral deadbolt to be retracted via actuation of the lock trim actuator with little to no interference from clamp 310. When the door is opened again, and the trigger is no longer held in the trigger retracted position, trigger biasing mechanism 314 may bias the trigger back to the trigger extended position and bias the clamp 310 back to the grasped position. In some embodiments, trigger biasing mechanism is disposed on a head portion 315 of the clamp and configured to contact a portion of the peripheral deadbolt assembly housing 301. In some embodiments, the trigger biasing mechanism may directly contact the trigger 312 (e.g. be disposed between a rear portion of the trigger and the trigger housing 316). While the trigger housing 316 is shown in FIG. 5 as a separate housing from housing 301, it is contemplated that the trigger housing 316 and the peripheral deadbolt assembly housing 301 may be a single housing.

FIG. 8 shows a bottom view of the peripheral deadbolt assembly 300 with a portion of the trigger housing 316 removed. In some embodiments, it may be desirable to adjust how far the trigger extends from the housing 301 when in the trigger extended position. Such a configuration may allow the trigger 312 to be adjusted to correspond to the size of the gap between the door and the door jamb. The trigger may therefore include a trigger adjustment mechanism 326. The trigger adjustment mechanism 326 may include access hole 328 to allow for adjustment of bolt 330 (e.g. using a screwdriver, an Allen wrench, etc.). Bolt 330 may pass through the lower portion 318 of clamp 310, and fasten to a nut 332, which is held stationary relative to the trigger 312. The trigger adjustment mechanism 326 may also include an adjustment biasing mechanism 334 configure to bias the lower portion of clamp 310 against the head of the bolt 330. As the bolt is tightened, the clamp remains relatively stationary due to trigger biasing mechanism 314, so the trigger 312 will move to a more extended position. If the bolt is loosened, the adjustment biasing mechanism 334 will expand, pushing the trigger 312 to a less extended position.

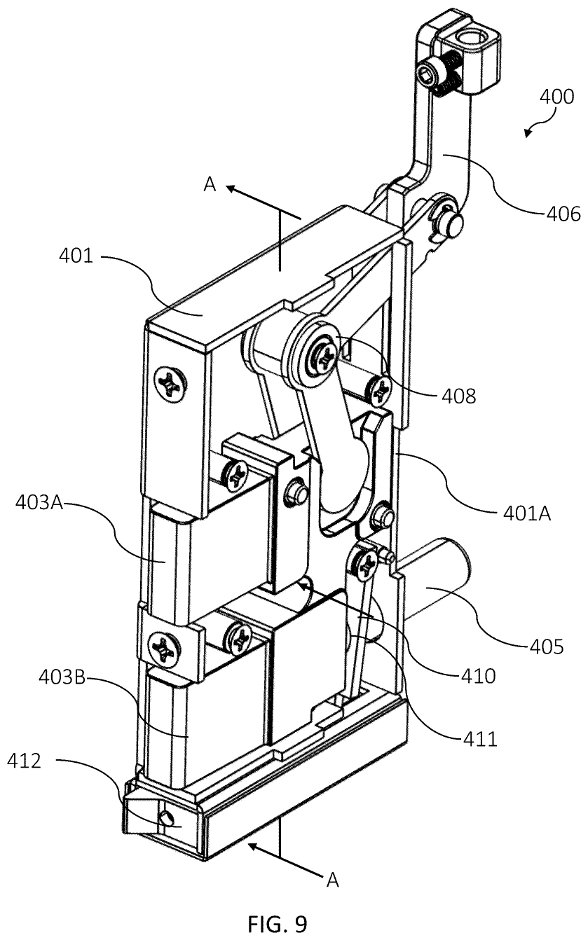

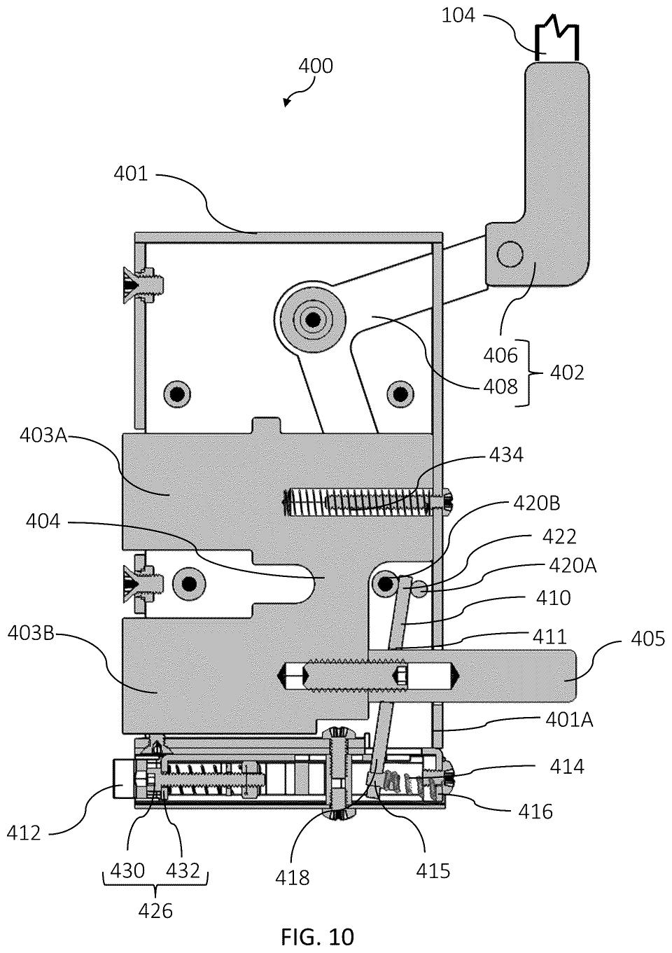

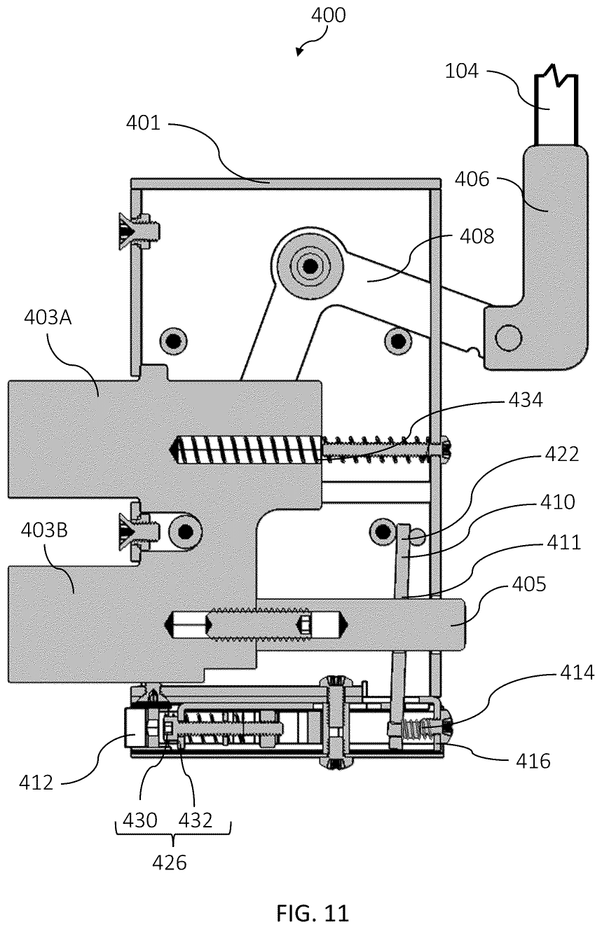

FIG. 9 shows a perspective view of a peripheral deadbolt assembly 400 according to another embodiment, with a portion of housing 401 removed. FIGS. 10 and 11 show cross sectional views of the peripheral deadbolt assembly 400 taken along section line A-A in the deadbolt retracted and deadbolt extended positions, respectively.

As discussed above, the inventors have recognized that configuring the trigger to slide between the trigger extended position and the trigger retracted position approximately parallel to the direction of travel of the peripheral deadbolt may allow for more flexibility in positioning the clamp relative to the peripheral deadbolt, and may allow for more flexibility in the configuration of the bolt head of the peripheral deadbolt.

For instance, as seen in FIG. 10, the clamp 410 may be positioned adjacent to a rear side 401A of the peripheral deadbolt assembly housing 401 and configured to grasp a rear portion 405 of the peripheral deadbolt 404. Trigger 412 extends along the length of the peripheral deadbolt 404, and is operatively connected to a lower portion 418 of clamp 410 at a rear portion of the trigger 412. Trigger 412 may therefore actuate clamp 410 in a similar manner to trigger 312 actuating clamp 310 described above.

Because the rear portion 405 of the peripheral deadbolt 404 is configured to be grasped by clamp 410, the size and shape of the deadbolt head 403 is not dictated by the functional requirements of clamp 410, allowing deadbolt head 403 to have a different shape, size, and/or cross-sectional profile than the rear portion 405. For instance, as seen in FIG. 9, deadbolt head 403 comprises two rectangular deadbolt head portions 403A and 403B. In some embodiments, head portions 403A and 403B are integrally formed from a single material. Such a size and shape of deadbolt head 403 may otherwise be impractical if the deadbolt head 403 needed to bind against a hole in clamp 410. In some embodiments, the deadbolt head 403 is removable from the rear portion 405. Such a configuration may allow for a variety of different deadbolt heads 403 to be attached to rear portion 405. Such a configuration may be desirable to allow the peripheral deadbolt assembly 403 to be usable on a variety of different door jambs with different sizes, shapes, and/or styles of receiver pockets without needing to redesign clamp 410.

The peripheral deadbolt 404 may move between deadbolt extended and deadbolt retracted positions in substantially the same manner as peripheral deadbolt 304 discussed above. Peripheral transmission unit 402 may operatively connect the peripheral deadbolt 404 to connector rod 104 via linkages 406 and 408, such that the peripheral deadbolt 404 moves between deadbolt extended positions and deadbolt retracted positions in unison with any other deadbolt in the door lock system. However, in some embodiments, the inventors have recognized that it may be desirable to include a deadbolt biasing mechanism 434 configured to contact the peripheral deadbolt 404 and bias all the deadbolts towards the deadbolt extended position, in addition to or as an alternative to biasing mechanism 216 described above.

The clamp 410 may function substantially similarly to clamp 310 described above. Clamp 410 may include a lower clamp portion operatively connected to trigger 412, such that the lower portion 418 slides with the trigger 412 as the trigger moves between trigger retracted and trigger extended positions. However, the clamp 410 may be prevented from sliding with the trigger by projections 420A and 420B, such that the clamp 410 must rotate to a released position about pivot point 422 as the lower portion 418 is moved by the trigger 412. As the clamp 410 rotates to be closer to perpendicular with the direction of travel of the peripheral deadbolt, hole 411 becomes more aligned with the cross-sectional profile of the rear portion 405 of peripheral deadbolt 404, reducing or removing the binding force between the hole 411 and the peripheral deadbolt 404.

When the door is closed, the trigger 412 may remain in the trigger retracted position shown in FIG. 11 due to contact with the door jamb, holding the clamp 410 in the released position. Such a configuration may allow for the peripheral deadbolt 404 to be retracted via actuation of the lock trim actuator with a little to no interference from the clamp 410. When the door is opened again, and the trigger 412 is no longer held in the trigger retracted position, trigger biasing mechanism 414 may bias the trigger back to the trigger extended position and bias the clamp back to the grasped position. In some embodiments, trigger biasing mechanism 414 is disposed on a head portion 415 of the clamp and configured to contact a portion of the trigger housing 416.

Trigger adjustment mechanism 426 may function substantially similarly to trigger adjustment mechanism 326, except that instead of the lower portion 418 of clamp 410 directly contacting the bolt head of bolt 430, a connector bar 432 extends along the length of the trigger 412 from the bolt head 430 to the lower portion 418 of the clamp 410 to operatively connect the clamp 410 to the trigger adjustment mechanism 426.

As discussed above, any number or combination of peripheral deadbolt assemblies 300/400 may be incorporated into door lock system 100. In some embodiments, each of the peripheral deadbolt assemblies include any of the clamp and triggers described above, such that simultaneous actuation of all the triggers is required to deploy the deadbolts. In some embodiments, only one or some of the peripheral deadbolt assemblies include the triggers and clamps. In some embodiments, the lock body 200 may include a clamp and trigger operatively connected to the lock body deadbolt 204 in addition to or as an alternative to a clamp and trigger connected to a peripheral deadbolt assembly 300/400.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An automatic deadbolt assembly comprising:
a deadbolt configured to move between a deadbolt retracted position and a deadbolt extended position, wherein at least a portion of the deadbolt is configured to be received into a pocket of a door jamb in the deadbolt extended position, wherein the deadbolt is configured to be biased towards the deadbolt extended position by a deadbolt biasing mechanism;
a clamp configured to move between a grasped position, where the clamp grasps the deadbolt to prevent movement of the deadbolt to the deadbolt extended position, and a released position, where the clamp releases the deadbolt; and
a trigger operatively connected to the clamp and configured to move approximately parallel to the deadbolt between a trigger extended position and a trigger retracted position;
wherein the trigger is configured to move the clamp to the released position when the trigger is moved to the trigger retracted position, allowing the deadbolt to move to the deadbolt extended position via force from the deadbolt biasing mechanism.

2. The automatic deadbolt assembly of claim 1, wherein the deadbolt biasing mechanism is external to the automatic deadbolt assembly, and wherein the deadbolt is configured to move to the deadbolt retracted position via force from an actuator external to the automatic deadbolt assembly.

3. The automatic deadbolt assembly of claim 2, further comprising a transmission unit configured to transmit forces from the actuator and the deadbolt biasing mechanism to the deadbolt.

4. The automatic deadbolt assembly of claim 3, wherein the transmission unit is configured to receive forces from the actuator and from the deadbolt biasing mechanism in a direction approximately perpendicular to a direction of travel of the deadbolt as the deadbolt moves between the deadbolt retracted position and deadbolt extended position.

5. The automatic deadbolt assembly of claim 4, wherein the transmission unit comprises a sliding linkage configured to slide in a direction of travel approximately perpendicular to the direction of travel of the deadbolt and at least one rotating linkage configured to rotate about an axis approximately perpendicular to both the direction of travel of the deadbolt and the direction of travel of the sliding linkage.

6. The automatic deadbolt assembly of claim 4, wherein the transmission unit comprises at least one rotating linkage configured to rotate about an axis approximately perpendicular to the direction of travel of the deadbolt, and a sliding linkage configured to slide along an arc with a center at the axis of rotation of the at least one rotating linkage.

7. The automatic deadbolt assembly of claim 1, wherein the trigger is configured to move to the trigger retracted position via contact between the trigger and a portion of the door jamb.

8. The automatic deadbolt assembly of claim 7, further comprising a trigger biasing mechanism configured to move the clamp to the grasped position and to move the trigger to the trigger extended position when the trigger is not in contact with the portion of the door jamb.

9. The automatic deadbolt assembly of claim 1, further comprising a housing, wherein the clamp is at least partially disposed in the housing.

10. The automatic deadbolt assembly of claim 1, further comprising a housing, wherein the clamp is fully disposed in the housing.

11. The automatic deadbolt assembly of claim 1, wherein the deadbolt comprises a deadbolt head and a deadbolt rear portion, wherein the clamp is configured to grasp the deadbolt rear portion.

12. The automatic deadbolt assembly of claim 11, wherein the deadbolt head has a different cross-sectional profile than the deadbolt rear portion.

13. The automatic deadbolt assembly of claim 11, wherein the deadbolt head comprises a first head portion and a second head portion.

14. The automatic deadbolt assembly of claim 13, wherein the first head portion and second head portion are integrally formed.

15. The automatic deadbolt assembly of claim 1, wherein the clamp is a Jorgenson clamp.

16. The automatic deadbolt assembly of claim 1, further comprising a housing, wherein the deadbolt biasing mechanism is at least partially disposed in the housing.

17. The automatic deadbolt assembly of claim 1, further comprising a trigger adjustment mechanism configured to adjust a position of the trigger.

18. A lock system comprising:
a first deadbolt and a second deadbolt, each deadbolt configured to move between respective deadbolt retracted positions and respective deadbolt extended positions;
a transmission unit assembly extending between and operatively connecting the first deadbolt to the second deadbolt, such that the first deadbolt and the second deadbolt move together between the respective deadbolt extended positions and the respective deadbolt retracted positions;
a deadbolt biasing mechanism configured to bias the first deadbolt and the second deadbolt to the respective deadbolt extended positions;
a first clamp configured to move between a grasped position, where the first clamp grasps the first deadbolt to prevent movement of the first deadbolt and the second deadbolt to the respective deadbolt extended positions, and a released position, where the first clamp releases the first deadbolt;
a first trigger operatively connected to the first clamp and configured to move the first clamp to the released position when the first trigger is actuated;
a second clamp configured to move between a grasped position, where the second clamp grasps the second deadbolt to prevent movement of the first deadbolt and the second deadbolt to the respective deadbolt extended positions, and a released position, where the second clamp releases the second deadbolt; and
a second trigger operatively connected to the second clamp and configured to move the second clamp to the released position when the second trigger is actuated;
wherein simultaneous actuation of the first trigger and second trigger simultaneously moves the first clamp and the second clamp to respective released positions, allowing the deadbolt biasing mechanism to move the first deadbolt and the second deadbolt to the respective deadbolt extended positions.

19. The lock system of claim 18, wherein a direction of travel of each of the first deadbolt and the second deadbolt between respective extended and retracted positions is approximately parallel to each other.

20. The lock system of claim 18, wherein the first deadbolt is a first peripheral deadbolt, and the second deadbolt is a second peripheral deadbolt, and further comprising a lock body and a lock body deadbolt disposed in the lock body, wherein the transmission unit assembly operatively connects the lock body deadbolt to the first peripheral deadbolt and the second peripheral deadbolt.

21. The lock system of claim 20, wherein the deadbolt biasing mechanism is disposed in the lock body and configured to contact the lock body deadbolt.

22. The lock system of claim 21, further comprising a first peripheral deadbolt housing and a second peripheral deadbolt housing, wherein the deadbolt biasing mechanism is a first deadbolt biasing mechanism, and further comprising a second deadbolt biasing mechanism configured to contact the first peripheral deadbolt and a third deadbolt biasing mechanism configured to contact the second peripheral deadbolt.

23. The lock system of claim 20, further comprising a spindle cam disposed in the lock body and operatively connected to the transmission unit assembly, such that actuation of the spindle cam moves all deadbolts to respective retracted positions.

24. The lock system of claim 23. wherein the spindle cam is configured to be actuated by a lock trim actuator of a lock trim assembly.
